(19) United States
(12) Patent Application Publication
(10) Pub. No.: US 2002/0197442 A1
(43) Pub. Date: Dec. 26, 2002

(54) Insulating fabrics

(76) Inventors: Daniel M. Wyner, N. Scituate, RI (US); John M. Leary, Norfolk, MA (US); Robert Daniel Harris JR., Kennesaw, GA (US)

Correspondence Address: DAVID L. FEIGENBAUM, Fish & Richardson P.C., 225 Franklin Street, Boston, MA, 02110-2804, US

(21) Appl. No.: 09/875,729

(22) Filed: Jun. 6, 2001

(51) Int. Cl. D04H 11/00; B32B 3/02; D05C 17/00

(52) U.S. Cl. 428/85; 442/388; 428/192; 428/193; 428/318.4; 442/373

(57) ABSTRACT

A fabric laminate is provided, including first and second facing layers and a foam layer interposed between the facing layers, at least one of the first and second facing layers including a veloured nonwoven material. Blankets are also provided.

### TECHNICAL FIELD

This invention relates to insulating fabrics.

### BACKGROUND

Heat-insulating fabrics used in blankets include, for example, woven fabrics, such as cotton or wool thermal fabrics, knits, such as acrylic or polyester knits, and nonwovens, such as needle-punched polyesters.

The warmth of blankets made of these materials is directly proportional to the fiber weight of the material. Thus, warm blankets made of these materials tend to be heavy. Blankets made of these materials may also deteriorate rapidly when laundered under commercial conditions, for example, when the blankets are used in a motel.

U.S. Pat. No. 3,528,874 describes a lightweight, inexpensive blanket material that includes one or more foam layers and a reinforcing ply, e.g., of textile fibers. The reinforcing ply is interposed between two layers of foam, or joined to a single foam layer, to provide tear resistance. Flocking on one surface or both surfaces of the foam provides a fuzzy, textured surface. Blankets embodying this technology are sold under the tradename “VELLUX.”

### SUMMARY

The invention features insulating (e.g., heat-insulating) fabrics and blankets formed of these fabrics.

In one aspect, the invention features a fabric laminate including first and second facing layers and a foam layer interposed between the facing layers, at least one of the first and second facing layers including a veloured nonwoven material.

Implementations may include one or more of the following features. Both of the facing layers include a nonwoven material, for example, a veloured nonwoven such as a needle-punched veloured material. The foam layer includes a urethane foam, e.g., a polyester or polyether urethane. The fabric laminate has a weight of from about 3 to 12 osy, e.g., from about 4 to 9 osy. The fabric laminate is substantially free of adhesives and binders. The foam layer has a thickness of from about 0.020 to 0.500 inch, e.g., from about 0.040 to 0.200 inch. The foam layer has a density of from about 0.7 to 6 lb/ft³, e.g., from about 1 to 5 lb/ft³. The foam layer includes a skived foam. Each facing layer has a weight of from about 0.75 to 15 osy, e.g., from about 1 to 10 osy. The facing layers have a needled density of from about 100 to 3000 punches per square inch. The veloured nonwoven material has a pile height of at least about 0.1 inch, e.g., from about 0.3 to 0.5 inch.

In another aspect, the invention features a sleeping blanket including (a) a laminate of a pair of first and second facing layers and a foam layer interposed between the facing layers, at least one of the facing layers comprising a nonwoven material, and (b) a finished edge on one or more of the edges of the sleeping blanket. The nonwoven material may include a veloured nonwoven.

The invention further features a method of making a fabric laminate including laminating a pair of facing layers to opposed surfaces of a foam layer, at least one of the facing layers including a veloured nonwoven material.

Some implementations include one or more of the following features. The laminating step includes flame laminating. Both of the facing layers include a nonwoven material. The method further includes needle-punching fibers to form the nonwoven material. The method further includes re-needling to produce the veloured surface of the veloured nonwoven material.

The invention also features an insulative material including a foam core sandwiched between two facing layers, at least one of the facing layers being laminated to the foam core layer and comprising a veloured nonwoven continuous fabric.

The term “veloured”, as used below, refers to a material that has a relatively smooth, dense face and an opposite, fuzzy face. Veloured nonwovens may be manufactured according to the velouring processes described here or by other processes.

Among the advantages of the invention, the insulating fabrics can be used to form lightweight, relatively inexpensive launderable blankets.

The insulating fabrics utilize air trapped in the foam layer to provide warmth, at relatively low weights. In some implementations, the blankets have a weight of less than about 30 ounces per square yard (osy), more preferably less than about 12 osy, and most preferably about 2.0 to 7.5 osy.

The blankets are launderable under commercial conditions. In some implementations, the blankets can undergo long-term frequent commercial laundering and still maintain a relatively new appearance. Generally, the blankets also exhibit minimal pilling, even after commercial laundering.

The insulating fabrics have desirable drape characteristics. These drape characteristics provide comfort when the fabrics are used in blankets, because the blankets will generally have a sheet-like drape, rather than bunching around the sleeper.

The insulating fabrics have desirable aesthetic qualities such as an attractive appearance and a soft, warm, dry hand. The appearance and hand of the fabrics can be easily varied by using different materials for the facing layers. The facing layer material(s) can be selected to provide a desired balance of aesthetic qualities, weight, launderability, durability and cost, to suit a particular application. By selecting certain facing layers, the heat-insulating fabrics can be made to resemble traditional woven or knitted blanket materials, for example by providing the fabric with a texture and hand similar to wool, velour, or fleece.

Other features and advantages of the invention will be apparent from the description and drawings, and from the claims.

### DESCRIPTION OF DRAWINGS

FIG. 1 is a highly enlarged diagrammatic cross-sectional view of a fabric.

FIG. 2 is a diagrammatic top view of a blanket.

FIG. 3 is a diagrammatic perspective view of a machine suitable for producing a veloured nonwoven web.

FIG. 4 is a diagrammatic side view of a veloured nonwoven material.

FIGS. 5-5A are graphs showing compressive data for the fabric material of the EXAMPLE

FIGS. 6-6A are graphs showing tensile data for the fabric material of the Example.

### DETAILED DESCRIPTION

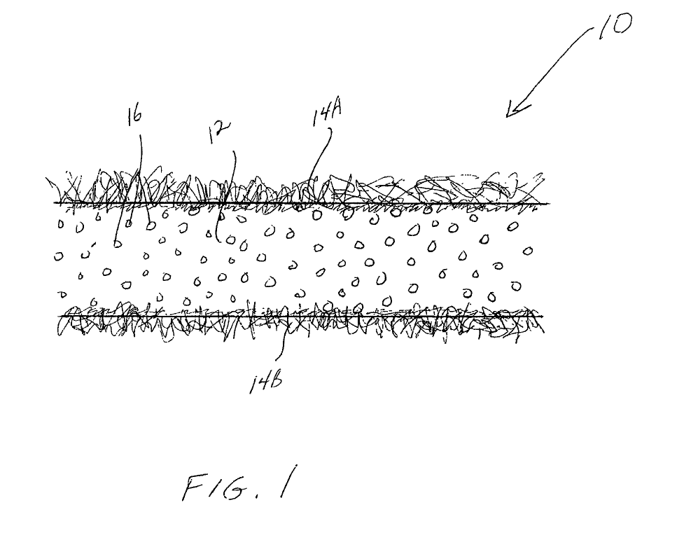

Referring to FIG. 1, a heat-insulating fabric 10 includes a foam layer 12 interposed between a pair of facing layers 14A, 14B. The facing layers are formed of a continuous sheet material, for example a nonwoven web, a film, or a knitted or woven textile. As will be discussed below, while the facing layers have relatively low resistance to deformation, when laminated to the foam layer they impart sufficient structural integrity to provide a desired degree of durability, tear resistance and launderability to the fabric. The fabric has good structural integrity and mechanical properties, without the need for reinforcement, e.g., by a scrim or stitching.

Preferably, fabric 10 has a weight of from about 2 to 30 osy, more preferably about 4 to 9 osy, and most preferably about 6.5 to 7.5 osy. Preferred fabrics can withstand at least 20 commercial laundering cycles, more preferably at least 50 commercial laundering cycles. By “withstand”, we mean that the fabric will retain its functionality for the application for which it is intended, e.g., in a blanket material, the fabric will maintain sufficient structural integrity to resist tearing in normal use, and will have a generally acceptable appearance. A blanket having a generally acceptable appearance may exhibit slight pilling or other changes to the pile, but will not have a loose, unkempt appearance. A “commercial laundering cycle” consists of washing the fabric using a laundry detergent intended for commercial use, for example a detergent available from Ecolab, in a commercial washer at a water temperature of 160° F. or less, and drying the fabric in a commercial dryer at a drying temperature of 180° F. or less.

Fabric 10 has a soft hand and good drape. These characteristics can be generally quantified using a Thwing-Albert Handleometer testing device. Preferably, using this device with a slot width of 10 mm and a sample size of 4×4 inches, the fabric, prior to laundering, exhibits a Handleometer reading of less than 400 grams force, more preferably less than 300 grams force.

The foam and facing layers are laminated together using techniques that will be described in detail below. The lamination process does not require the use of a binder, and thus the cells 16 of the foam remain open and as a result provide a reservoir of trapped air for thermal insulation.

Suitable materials for the foam layer 12 are laminatable, preferably by flame lamination, have a high moisture vapor transmittability (sufficiently high for user comfort when the fabric is used in a blanket), and have a pleasing weight and drape that is suitable for use in blankets. Preferred foams include cured (cross-linked) skived foam sheet materials. Suitable foamable materials for use in such foams include polyether polyurethanes, polyester polyurethanes, polyethylenes and polyvinyl polymers. Polyether and polyester polyurethanes work well due to their desirable drape and moisture vapor transmittability properties. Cured, skived polyether and polyester polyurethane foams are commercially available, for example polyester polyurethane product style no. 40310005 from General Foams, Paramus, N.J.

Cured, skived foams are manufactured using well-known round block or flat block manufacturing processes which involve foaming a liquid composition within a molding tunnel, removing a block of foamed material from the tunnel and allowing it to cure, and skiving thin layers of foam off of the block on a peeling machine.

Cured cast foams may also be used, e.g., foams manufactured by pouring a thin film of a foaming polymer composition onto a moving belt. Cast foams tend to be relatively more expensive than skived foams, but also generally have a very soft feel and desirable super-absorbent properties.

Preferably, the foam layer has a thickness of from about 0.020 to 0.500 inch, more preferably 0.040 to 0.200 inch, and most preferably from about 0.060 to 0.150 inch. Thinner foams are less expensive and provide a more drapeable product, but also provide less thermal insulation. Thicker foams provide greater insulation, but may in some cases result in a fabric that is undesirably “foam-like” and non-drapeable.

Suitable foams generally have a density of from about 0.7 to 6 pounds per cubic foot (lb/ft³), preferably about 1 to 5 lb/ft³, and more preferably about 1.5 to 3 lb/ft³. Light foams are relatively inexpensive and generally provide desirable drape and comfort, but may tend to be less durable for a given facing layer material. Heavier foams are generally more expensive and provide less drape, but tend to provide higher durability and a stiffer feel, which may be desirable in some applications. Preferably, the foam is an open-celled foam.

The facing layers may be of any desired continuous sheet material, including nonwoven webs, polymeric films, or knitted or woven textiles. Suitable facing layers provide the fabric with durability, tear resistance and launderability, and impart desired aesthetic qualities, such as attractive colors and patterns, luxurious textures, good drape, and a soft, warm hand. Preferred facing layer materials also provide moisture vapor transmittability, desirable drape and comfort, and flame retardant properties.

Preferred fibers for the facing layers include polyester, acrylics, polypropylene, rayon, cotton, and blends of these fibers. Other suitable fibers include aramid, carbon, fluorocarbon, glass, phenolic, polyacrylate, polyacrylonitrile, polyamide (e.g., NYLON), polybenzimidazole (PBI), polyimide, RAYON, TENCEL, and blends of these fibers. Preferably, the fibers are from about 0.5 to 5.0 inches long, and have a denier of from about 0.5 to 20, more preferably 0.5 to 7.

Preferably at least one of the facing layers includes a nonwoven web, more preferably an entangled nonwoven web. The nonwoven web may be entangled using any suitable process, e.g., needling, hydroentanglement, and other mechanical processes that intertwine the fibers in a substantially random way to provide an integral web. Entanglement provides the web with a degree of structural integrity, allowing it to be laminated to the foam layer, and providing the resulting fabric laminate with multi-directional strength without the need for stitching or other additional reinforcement.

Suitable entangled nonwoven webs include needle-punched nonwovens. Needle-punched nonwovens are well known in the textile field, and are typically manufactured by fiber opening, web-forming (e.g., carding, garnetting, airlaying or spunbonding), cross-lapping (horizontal or camel-back), pre-needling and finish needling staple fibers in needle looms. Needle-punching generally involves driving some of the fibers of a web or batt in a vertical direction through the web or batt (upwards and/or downwards) by needling the web or batt with barbed needles. The needling action interlocks the fibers and produces a three-dimensional fabric with greater structural integrity than the initial web or batt.

Suitable needle-punched nonwovens may be formed of any synthetic or natural fibers that are processable in a needle-punch process.

The entangled nonwoven web, e.g., a needle-punched nonwoven, may be veloured, to impart a soft, plush fleece finish to one surface of the veloured nonwoven web and a tight, relatively smooth finish to the opposite surface. A suitable veloured material 40, having a fuzzy side 42 and a smooth side 44, is shown diagrammatically in FIG. 4. The smooth side 44 includes densified, compacted fibers 46, while the fuzzy side includes lofty pile fibers 48. Preferably the fleece surface has a pile height H of at least 0.10 inch, more preferably from about 0.30 to 0.50 inch, and the smooth surface has a density of from about 100 to 3000 punches per square inch (punches during a needleloom velouring process, e.g., as described below).

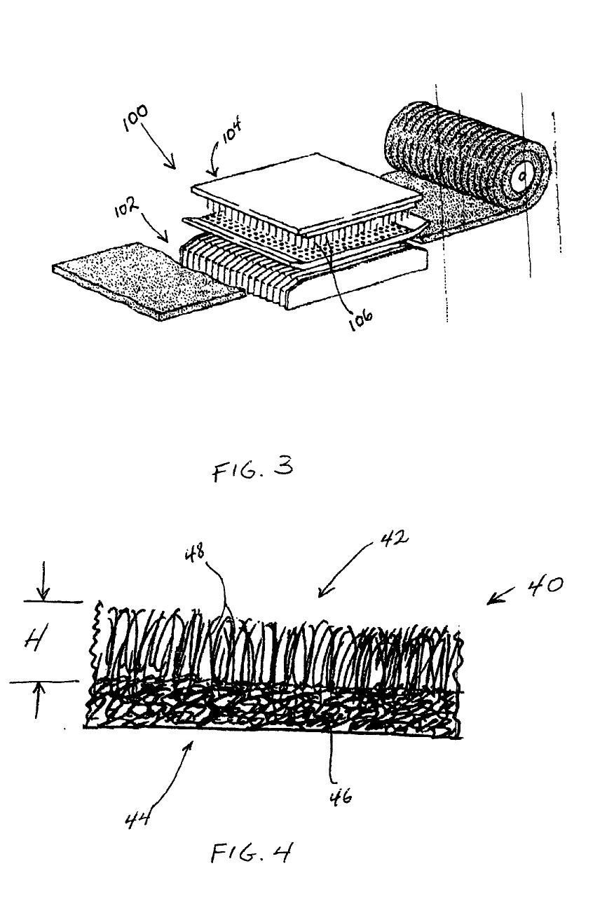

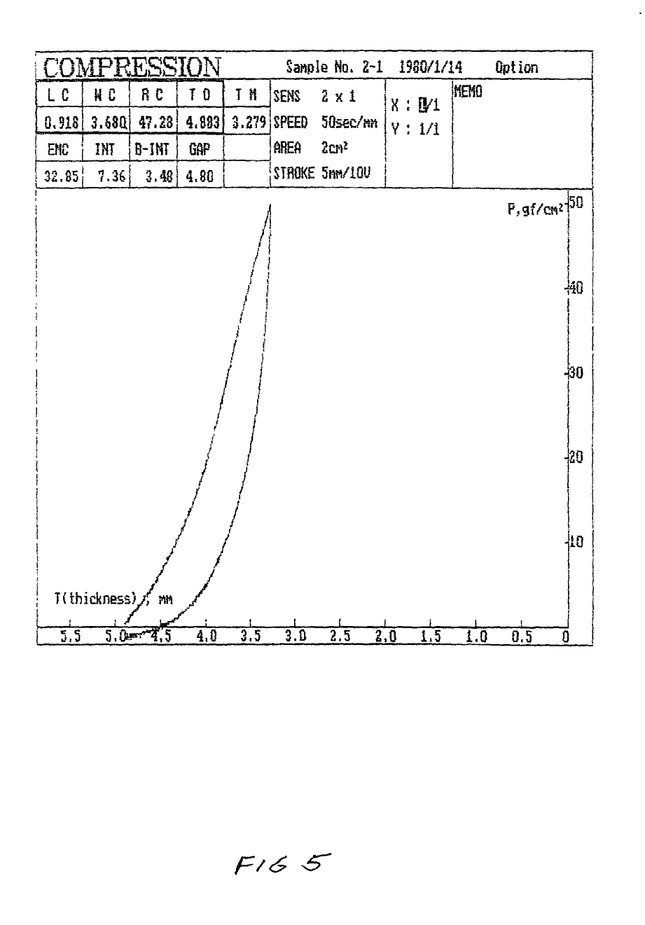

Velouring may be accomplished by passing the web through a needleloom velouring machine which needles the web to increase the number of fiber ends on one side of the web. A suitable velouring machine is commercially available from Asselin, and is shown schematically in FIG. 3. Velouring machine 100 includes a fine bristle bed 102, and an opposite plate 104 which includes barbed needles 105 (forked or crown-type). The barbed needles are passed through the nonwoven web, catching fibers and carrying them through the web towards the bristle bed. The bristles hold the fibers, preventing them from being dragged back through the web and thereby creating a fleece surface on the bristle-side of the web. The pile height and volume of the fleece surface can be changed by varying the depth and density of the barbed needles and/or the bristles. The bristles can be arranged in rows, as shown in FIG. 3, or arranged in other patterns, to create a patterned fleece surface. The action of the barbed needles densifies the needle-side of the web and creates a relatively smooth surface on this side.

When a veloured nonwoven is used as a facing material, the smooth surface is laminated to the foam layer 12, leaving the soft, plush side exposed to provide the fabric 10 with a soft, luxurious feel. The smooth surface provides a uniform, substantially continuous bond with the foam layer after lamination. The planar orientation of the fibers on the soft side of the veloured nonwoven provides a soft, warm, dry hand. Fabric laminates that include veloured nonwoven materials tend to exhibit little or no pilling, even when commercially laundered.

A soft, fuzzy surface may be imparted to the nonwoven by other processes such as napping, brushing, teaseling, sueding and shearing. However, the needleloom velouring process described above is generally preferred because it tends to improve the tensile strength of the nonwoven web.

It is generally preferred that the fibers be dyed prior to needle-punching and re-needling, as it may be difficult to dye the relatively dimensionally-unstable nonwoven web using conventional piece-dying processes.

Suitable facing layer materials generally have a weight of from about 0.75 to 15 osy, more preferably about 1 to 10 osy. Increasing the weight of the facing material generally increases the thermal insulation, overall weight and cost of the fabric. Lower density facing layers generally provide the fabric laminate with better drape and hand than higher density facing layers.

The fabric may be manufactured using any desired lamination technique. Suitable techniques provide a bond that is substantially continuous over the surface area of the bonded layers. Preferred techniques, for example flame lamination, melt or flow the material at the surface of the foam layer to attach the facing layers to the foam without the use of an adhesive or binder. As noted above, when binders are not used the cells 16 of the foam remain open, to act as reservoir for air. The absence of binder also results in a soft, drapeable material.

The lamination process has been found to produce a strong, durable fabric laminate, even when the facing layers and foam layers that are used are relatively weak. The increase in strength that occurs as a result of lamination allows relatively light, low density facing materials to be used, which in turn contributes to the drape, hand and aesthetic properties of the fabric laminate.

To flame laminate the facing layers to the foam layer, the foam layer is exposed to a precisely controlled open gas flame burner, while moving the foam at a controlled speed at a set distance from the flame. The flame temperature, speed of the foam, and distance from the flame are controlled so that a region at the surface of the foam, typically about 0.010 to 0.020 inch deep, is melted slightly. This molten region is then joined under controlled pressure to the facing layers, the molten foam acting as an adhesive to bind the facing layers to the foam. Preferably, two gas burners are used so that both surfaces of the foam layer can be melted simultaneously.

Other suitable lamination techniques include gravure printed lamination using a single or multi-part adhesive, rotary screen or knife over roll lamination, dry web or film hot-melt lamination, or spray adhesive bonding. When adhesives or binders are used, it is preferred that they be cross-linkable, to provide durability and launderability. Suitable adhesives include solvent based, water based, 100% solids and hot-melt adhesives. Preferably, the adhesive is applied in a discontinuous pattern, to allow the fabric to have sufficient drape.

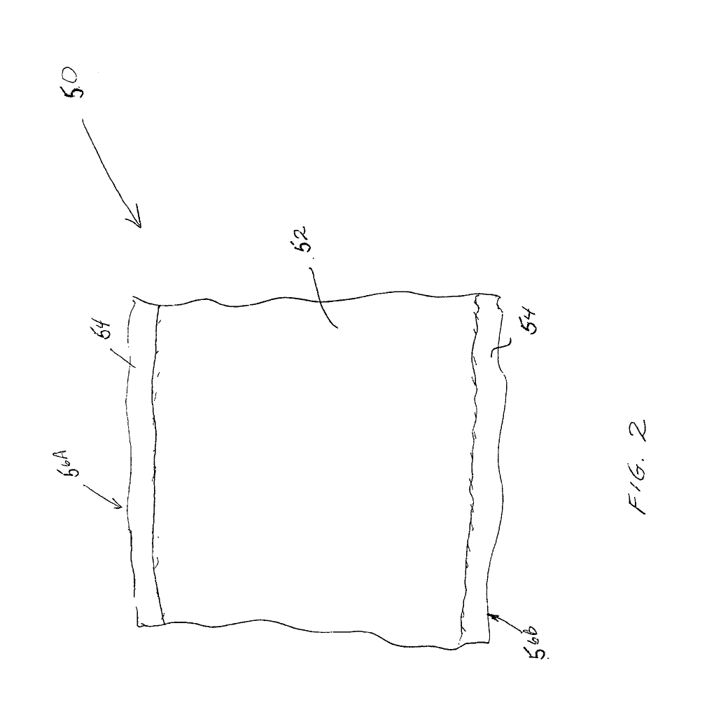

The fabrics discussed above provide good comfort, warmth, and durability when used in sleeping blankets, e.g., blanket 50 shown in FIG. 2. Blanket 50 includes a generally rectangular portion of fabric 52, and a finished edge 54 on opposite edges 56A, 56B of the rectangular portion. Finished edge 54 may be a hemmed edge, e.g., a C-folded hem, a blanket trim, e.g., a ribbon or other decorative material stitched or laminated to the fabric, as is well known in the blanket art, or may be formed by embossing a decorative pattern along edges 56A, 56B. As is well known, sleeping blankets generally have dimensions on the order of at least 3 feet by 4 feet, up to 5 feet by 8 feet or more for a King sized blanket. Preferably, fabrics for use in blankets exhibit a thermal insulation, measured using ASTM D-1518-85 (reapproved 1998), of at least 1400 cm²·C⁰/W, more preferably at least 1500 cm²·C⁰/W. So that the blanket will exhibit good durability during normal use, it is generally preferred that the fabric exhibit the following mechanical properties, when tested using a Kawabata Evaluation System (available from Texmac, Charlotte, N.C.), with a load level of 50 g/cm² in compression and a load level of 500 grams per centimeter of width in tension, to approximate the stresses that will be experienced by a blanket in ordinary use:

EMC (% Compressibility): Less than about 40%, more preferably less than about 35%;

RC (% Compressive Resilience): At least about 40%, more preferably at least about 45%;

EMT (% Tensile Elongation): Less than about 20%, more preferably less than about 15%;

WT (Tensile Energy): Less than about 20, more preferably less than about 15; and

RT (% Tensile Resiliance): At least 25%, more preferably at least 30%.

### EXAMPLE

A fabric laminate was formed using the following materials and procedures. A polyester needle-punched fabric was veloured using an Asselin velouring machine (commercially available from Deitsch Plastics), to a pile height of approximately 0.050″ to 0.060″, a needled density of about 250 punches per square inch, and a cross-sectional thickness of about 0.040″ to 0.050″. Two sheets of the veloured nonwoven were flame laminated to a skived polyester polyurethane foam sheet (commercially available from General Foam, product style no. 40310005). The foam sheet had a thickness of 0.080″ prior to flame lamination and a density of 1.7 lb/ft³, and was open celled. Flame lamination was conducted at settings selected so that 0.018″ of foam on each side of the foam sheet was burnt off to achieve a destructive bond between the materials.

The resulting fabric laminate had a soft hand and good drape. The Handleometer reading (10 mm slot, 4×4″ sample) was 234 grams force in the cross-machine direction and 201 grams force in the machine direction. The material withstood 48 commercial laundering cycles, retaining a generally acceptable appearance and quality. The fabric remained functional and did not have a loose, unkempt appearance. Very little change in appearance was observed after the first 20 cycles.

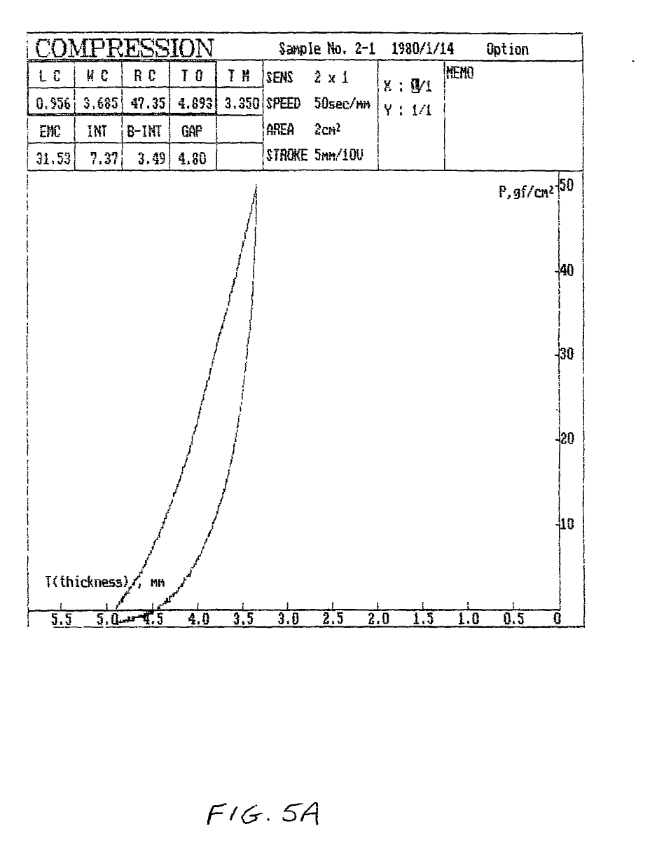

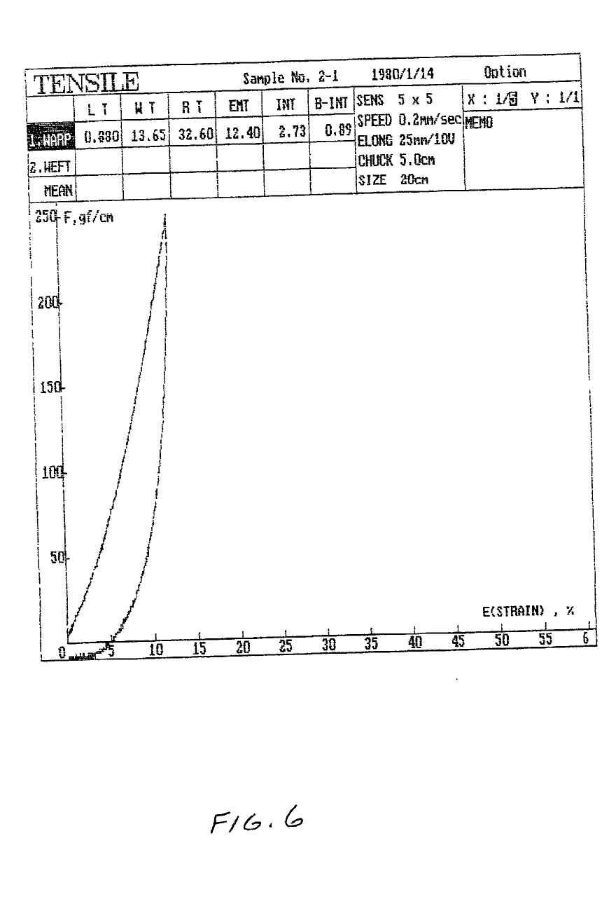

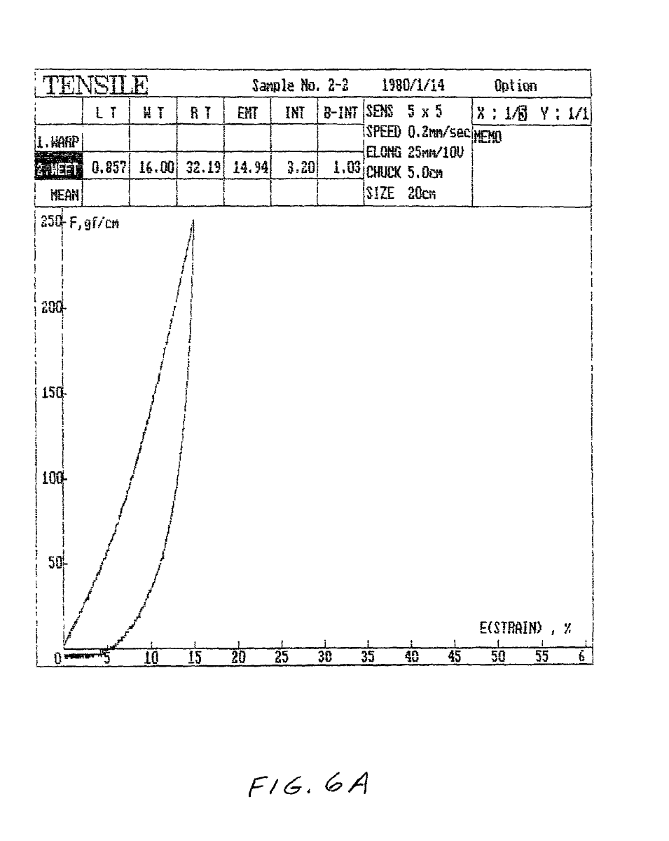

Two samples of the fabric laminate were tested for compressive and tensile properties, using a Kawabata Evaluation System (available from Texmac, Charlotte, N.C.), with a load level of 50 g/cm² in compression and a load level of 500 grams per centimeter of width in tension. The compressive data for the two samples is shown in FIGS. 5-5A. The tensile data for the two samples is shown in FIGS. 6-6A. FIG. 6 shows the laminate tested in the warp (machine) direction, while FIG. 6A shows the laminate tested in the weft (cross-machine) direction. These properties indicate that the fabric laminate would exhibit good durability in normal use as a blanket material.

The fabric laminate was also tested to determine its thermal properties, using ASTM D 1518-85 (reapproved 1998). The results were as follows:

| | | | Thermal | |
|---|---|---|---|---|
| | | | Conductivity | Thermal |
| | Weight, | Thickness | (“TC”) | Insulation |
| Material | (oz/sq.yd) | (mm) | (W/cm² · C⁰) | (1/TC) |
| Fabric Laminate | 6.882 | 5.085 | 6.836 × 10⁻⁴ | 1591 |

These results indicate that the fabric laminate would be suitable for use as a blanket material.

Other embodiments are within the scope of the following claims. For example, the two opposite facing layers could be different materials or have different characteristics or be laminated in different ways. A facing layer might be laminated on only one side of the foam layer with the other side exposed. That other exposed side could be protected by a fabric or other layer that is not bonded to the foam. The foam layer need not be a single layer, but could be two or more thin layers laminated to each other.

As one example of facing layers of different materials, a waterproof mattress pad may include a nonwoven facing layer on one side, and a waterproof film layer on the other side. Suitable waterproof films are launderable and flexible. Suitable films include vinyls, polyurethanes, polyethylenes, and metallocene derived polyethylenes. Preferably the film is from about 0.2 to 5 mils thick.

What is claimed is:

1. A fabric laminate comprising first and second facing layers and a foam layer interposed between the facing layers, at least one of the first and second facing layers comprising a veloured nonwoven material.

2. The fabric laminate of claim 1 wherein both of the facing layers comprise a nonwoven material.

3. The fabric laminate of claim 2 wherein both of the facing layers comprise a veloured nonwoven.

4. The fabric laminate of claim 1 wherein the foam layer comprises a urethane foam.

5. The fabric laminate of claim 4 wherein the urethane foam comprises a polyester or polyether urethane.

6. The fabric laminate of claim 1 wherein the fabric laminate has a weight of from about 3 to 12 osy.

7. The fabric laminate of claim 6 wherein the fabric laminate has a weight of from about 4 to 9 osy.

8. The fabric laminate of claim 1 wherein the veloured nonwoven material comprises a needle-punched nonwoven.

9. The fabric laminate of claim 2 wherein the facing layers comprise needle-punched nonwovens.

10. The fabric laminate of claim 1 wherein the fabric laminate is substantially free of adhesives and binders.

11. The fabric laminate of claim 1 wherein the foam layer has a thickness of from about 0.020 to 0.500 inch.

12. The fabric laminate of claim 11 wherein the foam layer has a thickness of from about 0.040 to 0.200 inch.

13. The fabric laminate of claim 1 wherein the foam layer has a density of from about 0.7 to 6 lb/ft³.

14. The fabric laminate of claim 1 wherein the foam layer has a density of from about 1 to 5 lb/ft³.

15. The fabric laminate of claim 1 wherein the foam layer comprises a skived foam.

16. The fabric laminate of claim 1 wherein each facing layer has a weight of from about 0.75 to 15 osy.

17. The fabric laminate of claim 16 wherein each facing layer has a weight of from about 1 to 10 osy.

18. The fabric laminate of claim 9 wherein the facing layers have a needled density of from about 100 to 3000 punches per square inch.

19. The fabric laminate of claim 1 wherein the veloured nonwoven material comprises fibers having a denier of from about 0.5 to 20.

20. The fabric laminate of claim 1 wherein the veloured nonwoven material comprises fibers selected from the group consisting of polyester, acrylics, polypropylene, rayon, cotton, and blends of these fibers.

21. The fabric laminate of claim 1 wherein the veloured nonwoven material comprises fibers having a length of from about 0.5 to 5.0 inches.

22. The fabric laminate of claim 1 wherein the veloured nonwoven material has a pile height of at least about 0.1 inch.

23. The fabric laminate of claim 22 wherein the veloured nonwoven material has a pile height of from about 0.3 to 0.5 inch.

24. A sleeping blanket comprising
a laminate of a pair of first and second facing layers and a foam layer interposed between the facing layers, at least one of the facing layers comprising a nonwoven material, and
a finished edge on one or more of the edges of the sleeping blanket.

25. The sleeping blanket of claim 24 wherein the nonwoven material comprises a veloured nonwoven.

26. The sleeping blanket of claim 24 wherein both of the facing layers comprise a nonwoven material.

27. The sleeping blanket of claim 26 wherein the nonwoven material comprises a veloured nonwoven.

28. The sleeping blanket of claim 24 wherein said finished edge comprises a hem.

29. The sleeping blanket of claim 24 wherein said finished edge comprises a blanket trim.

30. A method of making a fabric laminate comprising laminating a pair of facing layers to opposed surfaces of a foam layer, at least one of the facing layers comprising a veloured nonwoven material.

31. The method of claim 30 wherein the laminating step comprises flame laminating.

32. The method of claim 30 wherein both of the facing layers comprise a nonwoven material.

33. The method of claim 30 further comprising needle-punching fibers to form the veloured nonwoven material.

34. The method of claim 33 further comprising re-needling to produce the veloured surface of the veloured nonwoven material.

35. An insulative material comprising
a foam core sandwiched between two facing layers,
at least one of the facing layers being laminated to the foam core layer and comprising a veloured nonwoven continuous fabric.

36. The insulative material of claim 35 wherein the nonwoven continuous fabric comprises a needle-punched web.

37. The insulative material of claim 35 wherein the nonwoven continuous fabric has a pile height of at least 0.1 inch.

38. The insulative material of claim 35 wherein the nonwoven continuous fabric has a weight of from about 1.5 to 8 osy.

39. An insulative material comprising
a foam core sandwiched between two facing layers,
at least one of the facing layers being laminated to the foam core layer and comprising a veloured needle-punched nonwoven continuous fabric having a pile height of at least 0.1 inch and a weight of from about 1.5 to 8 osy.

40. A sleeping blanket comprising
a laminate of a pair of first and second facing layers and a foam layer interposed between the facing layers, at least one of the facing layers comprising a veloured needle-punched nonwoven material having a pile height of at least 0.1 inch, and
a finished edge on one or more of the edges of the sleeping blanket.

41. A fabric laminate comprising
first and second facing layers, and
a urethane foam layer having a thickness of from about 0.020 to 0.500 inch and a density of from about 0.7 to 6 lb/ft³ interposed between the facing layers,
at least one of the first and second facing layers comprising a veloured needle-punched nonwoven material having a pile height of at least 0.1 inch,
the fabric laminate having a weight of from about 3 to 12 osy and being substantially free of adhesives and binders.

42. The fabric laminate of claim 41 wherein each facing layer has a weight of from about 0.75 to 15 osy.

43. The fabric laminate of claim 42 wherein each facing layer has a weight of from about 1 to 10 osy.

44. The fabric laminate of claim 41 wherein the facing layers have a needled density of from about 100 to 3000 punches per square inch.

45. The fabric laminate of claim 41 wherein the veloured nonwoven material comprises fibers having a denier of from about 0.5 to 20.

46. The fabric laminate of claim 41 wherein the veloured nonwoven material comprises fibers selected from the group consisting of polyester, acrylics, polypropylene, rayon, cotton, and blends of these fibers.

47. The fabric laminate of claim 41 wherein the veloured nonwoven material comprises fibers having a length of from about 0.5 to 5.0 inches.

48. The fabric laminate of claim 41 wherein the veloured nonwoven material has a pile height of from about 0.3 to 0.5 inch.

49. An insulative material comprising
a foam core sandwiched between two facing layers,
at least one of the facing layers being laminated to the foam core layer and comprising a veloured needle-punched nonwoven continuous fabric having a pile height of at least 0.1 inch and a weight of from about 1.5 to 8 osy,
wherein said insulative material is substantially free of stitching and does not include a reinforcing scrim layer.

50. A sleeping blanket comprising
a laminate including
first and second facing layers, and
a urethane foam layer having a thickness of from about 0.020 to 0.500 inch and a density of from about 0.7 to 6 lb/ft³ interposed between the facing layers,
at least one of the first and second facing layers comprising a veloured needle-punched nonwoven material having a pile height of at least 0.1 inch,
the fabric laminate having a weight of from about 3 to 12 osy and being substantially free of adhesives and binders; and
a finished edge on one or more of the edges of the sleeping blanket.
